(19) United States
(12) Patent Application Publication
(10) Pub. No.: US 2018/0179046 A1
(43) Pub. Date: Jun. 28, 2018

(54) SADDLE COVER SYSTEMS AND METHOD

(71) Applicant: Patricia Gladys Stuka, County of Grande Prairie (CA)

(72) Inventor: Patricia Gladys Stuka, County of Grande Prairie (CA)

(21) Appl. No.: 15/392,972

(22) Filed: Dec. 28, 2016

(51) Int. Cl. B68C 1/12

(52) U.S. Cl. CPC B68C 1/126

(57) ABSTRACT

A saddle cover system is disclosed herein. The saddle cover prevents rubbing, scratching or in any way marring the saddle by the stirrup during storage.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of saddles and more specifically relates to saddle cover systems.

### 2. DESCRIPTION OF RELATED ART

The saddle is a supportive structure for a rider or other load, fastened to an animal's back by a girth. The most common type is the equestrian saddle designed for a horse. It is not known precisely when riders first began to use some sort of padding or protection, but a blanket attached by some form of surcingle or girth was probably the first saddle, followed later by more elaborate padded designs. Currently, modern saddles come in a wide variety of styles, each designed for a specific equestrianism discipline, and require careful fit to both the rider and the horse. Proper saddle care can extend the useful life of a saddle, often for decades. Saddles may be stored during non-use periods. Saddles may be rubbed, scratched or marred during storage which is not desirable.

U.S. Pat. No. 6,568,160 to Rita Ellinor Cortesi relates to stirrup and leather covers. The described stirrup and leather cover includes a removable stirrup cover and removable leather cover for providing substantial protection against abrasions and scuff marks of the flap and panel area of an english saddle. The covers consist of smooth, nonabrasive materials that help preserve the value and aesthetics of the English saddle. The stirrup cover is employed during storage of the saddle by placing the stirrup cover over the stirrup providing protection to the saddle. The leather cover is alternatively employed during use of the English saddle by covering the saddle leathers with the leather covers, preventing saddle abrasions created by the leathers rubbing against the panel area.

### BRIEF SUMMARY OF THE INVENTION

In view of the foregoing disadvantages inherent in the known saddles art, the present disclosure provides a novel saddle cover system. The general purpose of the present disclosure, which will be described subsequently in greater detail, is to provide a saddle cover which prevents rubbing, scratching or in any way marring the saddle by the stirrup(s) during storage.

A saddle cover system is disclosed herein. The saddle cover system includes a saddle cover including a flexible body defined by an outer surface, an inner volume, a thickness, and an inner surface; the outer surface being integral with the inner surface and separated via the thickness, the flexible body is configured to substantially wrap about a saddle during an in-storage condition to protect the saddle from damage. The flexible body further may have a stirrup-egress-aperture passing through the flexible body on a top side (positioning when used). The saddle cover allows the saddle to be covered via the flexible body substantially within the inner volume, and stirrups are able to egress from the stirrup-egress-aperture to be placed adjacent the outer surface of the flexible body such that the stirrups are isolated from touching the saddle during storage. The stirrups are separated from the saddle via the thickness of the saddle cover.

A method of using saddle cover system is also disclosed herein. The method of using the saddle cover system may comprise the steps of: inserting a saddle within an inner volume of a saddle cover, pulling stirrups through a stirrup-egress-aperture, and placing the stirrups adjacent an outer surface such that the stirrups do not contact the saddle during an in-storage condition.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a Saddle Cover System, constructed and operative according to the teachings of the present disclosure.

FIG. 1 is a front perspective view of the saddle cover system during an ‘in-use’ condition, according to an embodiment of the disclosure.

FIG. 2 is a side perspective view of the saddle cover system of FIG. 1, according to an embodiment of the present disclosure.

FIG. 3 is a front perspective view of the saddle cover system of FIG. 1, according to an embodiment of the present disclosure.

FIG. 4 is a front perspective view of the saddle cover system of FIG. 1, according to an embodiment of the present disclosure.

FIG. 5 is a flow diagram illustrating a method of use for the saddle cover system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to saddles and more particularly to a saddle cover system as used to improve the effectiveness of saddle storage such that longevity of the host saddle is promoted.

Generally, the saddle cover prevents rubbing, scratching or in any way marring the saddle by the stirrup(s) during storage. The present invention prevents damage to the saddle during storage caused from the stirrups, is easy to get on and off the saddle, will fit under any other saddle cover and has opening for billets if needed. Stirrups are normally slid up the leathers approximately ½ way for storage which increases the risk of damage to the saddle by rubbing or scratching. The saddle cover fits a saddle and has an opening in the top (preferably oval shaped) seamed with elastic for ease of getting the stirrups in and out. At the bottom of the panels a small section of the seam is left open for billet straps. Elastic is also on the front of the saddle cover so that it will virtually fit any saddle. In operation: the cover is placed over the saddle; the stirrups are brought up through the opening and placed on the outside of the cover; billets are placed through the bottom of the flaps seam opening for a close fit. The saddle cover effectively prevents the stirrups from rubbing or marring the saddle panels during storage.

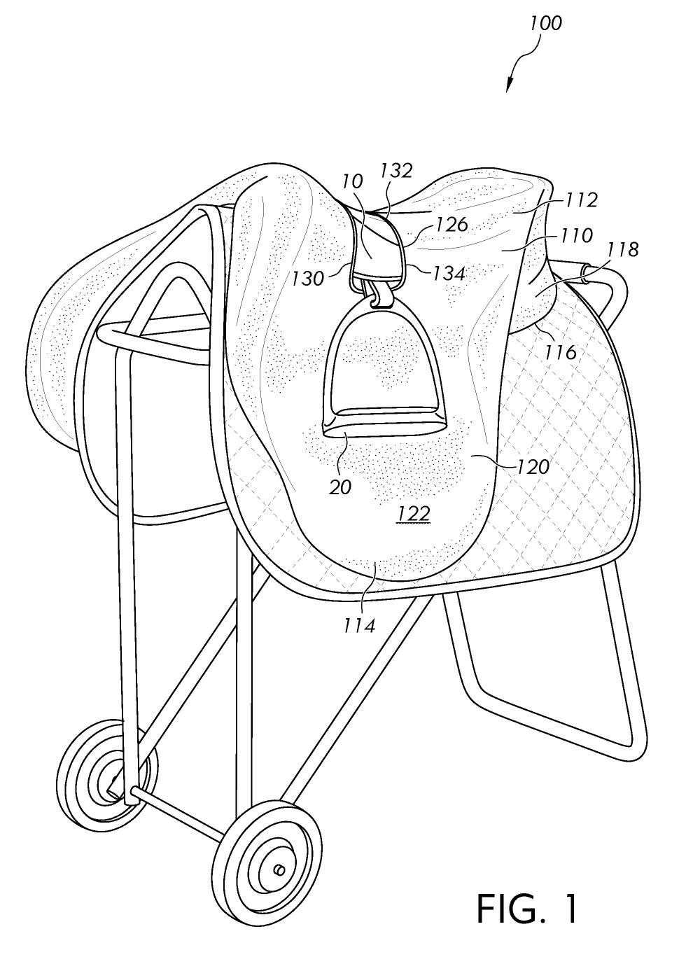

Referring now more specifically to the drawings by numerals of reference, there is shown in FIGS. 1-5, various views of a saddle cover system 100. FIG. 1 shows a saddle cover system 100 during an in-storage condition (‘in-use’ condition 150), according to an embodiment of the present disclosure. As illustrated, the saddle cover system 100 may include a saddle cover 110 including a flexible body 120 defined by an outer surface 122, an inner volume 124, a thickness 126, and an inner surface 128, the outer surface 122 being integral with the inner surface 128 and separated via the thickness 126. The flexible body 120 is configured to substantially wrap about a saddle 10 during an in-storage condition (‘in-use’ condition 150) to protect the saddle 10 from damage. The flexible body 120 further may have a stirrup-egress-aperture 130. The saddle cover 110 allows the saddle 10 to be covered via the flexible body 120 substantially within the inner volume 124, and stirrups 20 being allowed to egress from the stirrup-egress-aperture 130 to be placed adjacent the outer surface 122 of the flexible body 120 such that the stirrups 20 are isolated from touching the saddle 10 during storage.

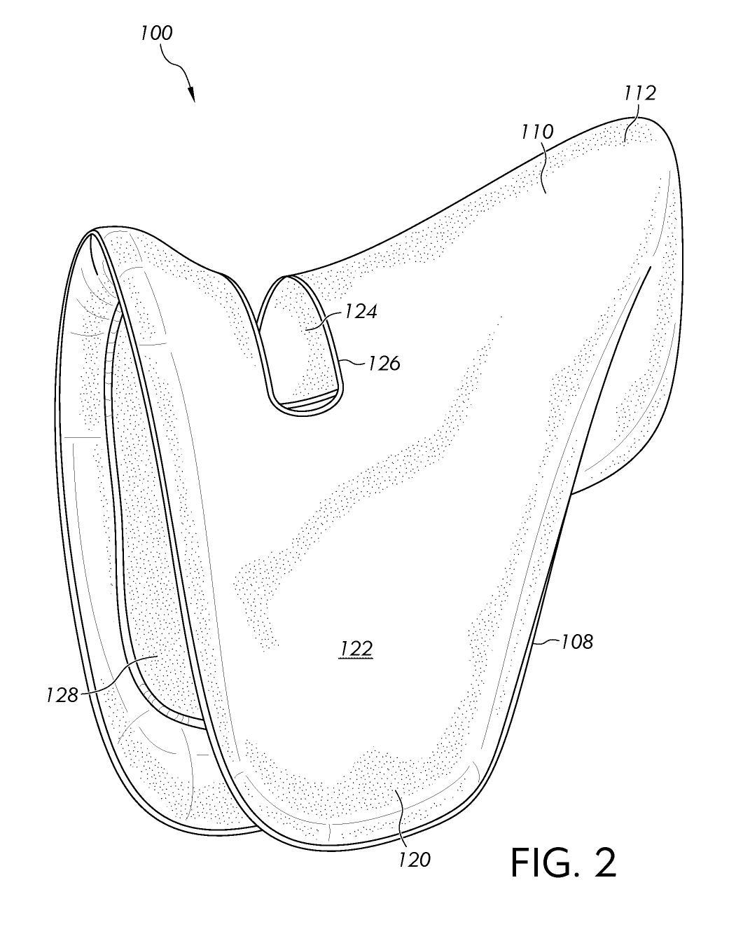

FIG. 2 shows a side perspective view of the saddle cover system 100 of FIG. 1, according to an embodiment of the present disclosure. As above, the saddle cover system 100 may include a cover 112 for an equestrian saddle (saddle 10); the equestrian saddle 10 having a top side 118 and a bottom side 116. The cover 112 (cover 112 and saddle cover 110 used interchangeably throughout) comprising: a flexible sheet 114 having an outer perimeter 108, and dimensioned to substantially cover the top side 118 of the equestrian saddle 10. The present invention comprises a saddle attachment configured to elastically couple to one or more portions of the bottom side 116 of the equestrian saddle 10. Elastic means may be used in one or more portions of the present invention.

A stirrup-egress 132 (stirrup-egress-aperture 130) is integrated with the flexible sheet 114; the stirrup-egress 132 including an elastic aperture 134 preferably positioned centric to the outer perimeter 108, the stirrup-egress 132 is dimensioned such that stirrups 20 fixed to the equestrian saddle 10 are able to be passed through the stirrup-egress via the elastic aperture 134 and placed atop the flexible sheet 114 without directly touching the equestrian saddle 10. The present invention provides an isolation means such that stirrups 20 do not contact the equestrian saddle 10.

The stirrup-egress 132 comprises a stirrup-egress-aperture 130; wherein the stirrup-egress-aperture 130 is substantially oval-shaped, as shown. The flexible sheet 114 comprises a substantially triangulated shape with rounded corners defined by the outer perimeter 108. The flexible sheet 114 comprises a flexible body 120 such that it may be contour fit about saddle 10. The substantially triangulated shape comprises ears; wherein the stirrups 20 are positioned adjacent the ears during an in-storage condition (‘in-use’ condition 150).

The stirrups 20 hang in as-ridden-stance when positioned for the in-storage condition (‘in-use’ condition 150) against an outer surface 122 of the flexible sheet 114 (they are pulled ½ way up the leathers, as shown). The cover 112 comprises an inner volume 124 during the in-storage condition (‘in-use’ condition 150). The cover 112 preferably comprises fleece but may comprise other suitably equivalent fabrics and non-fabrics. The cover 112 may further comprise billet-strap-openings in a seam-section. The elastic aperture 134 comprises at least one elastic member (means). The cover is able to fit under a second-cover (not shown). The flexible sheet 114 does not comprise abrasive material but rather preferably soft fabric or the like. As designed, the flexible sheet 114 is readily deformable to fit a host of saddles 10 which differ in shape and size. The flexible sheet 114 absorbs impact and provides means to prevent damage to the saddle 10.

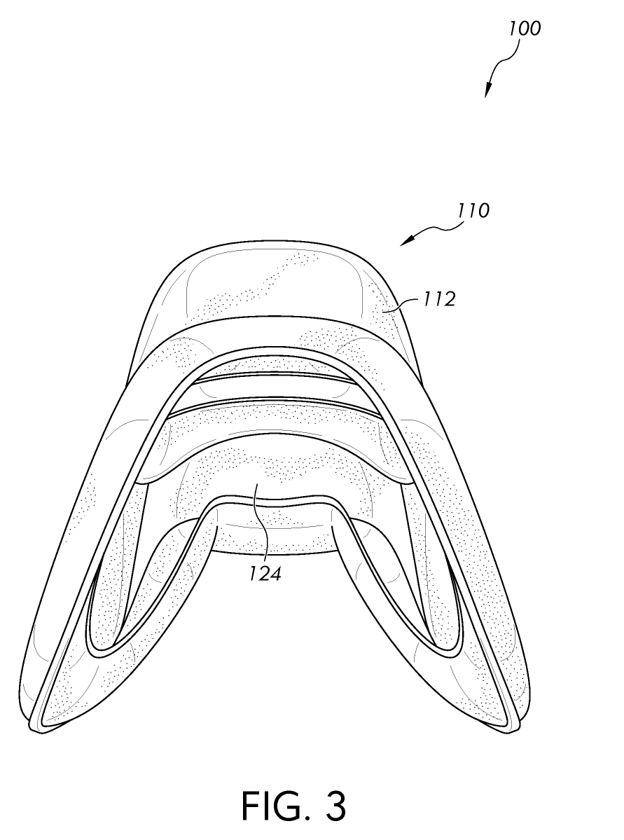

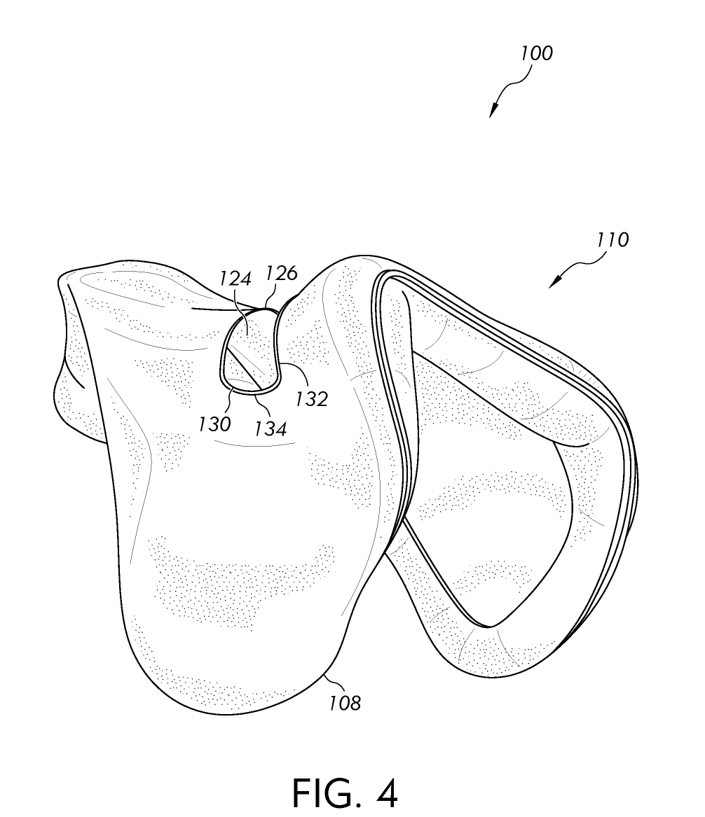

FIGS. 3-4 show perspective views of the saddle cover system 100 of FIG. 1, according to an embodiment of the present disclosure. As above, the saddle cover system 100 may include

In a preferred embodiment the saddle cover system 100 comprises: a saddle cover 110 including a flexible body 120 defined by an outer surface 122, an inner volume 124 (when formed for use), a thickness 126, and an inner surface 128; the outer surface 122 being integral with the inner surface 128 and separated via the thickness 126. The flexible body 120 is configured to substantially wrap about a saddle 10 during an in-storage condition (‘in-use’ condition 150) to protect the saddle 10 from damage. The flexible body 120 further has a stirrup-egress-aperture 130.

The saddle cover 110 allows the saddle 10 to be covered via the flexible body 120 substantially within the (formed) inner volume 124. The stirrups 20 are to egress from the stirrup-egress-aperture 130 to be placed adjacent the outer surface 122 of the flexible body 120 such that the stirrups 20 are isolated from touching the saddle 10 during storage. The saddle cover system 100 may further comprise a set of instructions and be arranged as a kit with a host saddle 10.

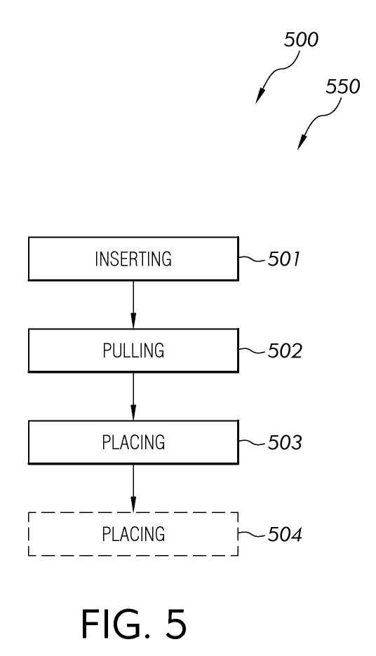

FIG. 5 is a flow diagram 550 illustrating a method of use 500, according to an embodiment of the present disclosure. As illustrated, the method of use 500 may include the steps of: step one 501 inserting a saddle within an inner volume of a saddle cover, step two 502 pulling stirrups through a stirrup-egress-aperture, and step three 503 placing the stirrups adjacent an outer surface such that the stirrups do not contact the saddle during an in-storage condition. Step four 504 billets may be placed through the bottom of the flaps seam opening for a close fit.

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for saddle cover system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cover for an equestrian saddle, the equestrian saddle having a top side and a bottom side, the cover comprising:
a flexible sheet having an outer perimeter, and dimensioned to substantially cover the top side of the equestrian saddle;
a saddle attachment configured to elastically couple to one or more portions of the bottom side of the equestrian saddle; and
a stirrup-egress integrated with the flexible sheet, the stirrup-egress including an elastic aperture positioned centric to the outer perimeter, the stirrup-egress dimensioned such that stirrups fixed to the equestrian saddle are able to be passed through said stirrup-egress via said elastic aperture and placed atop the flexible sheet without directly touching the equestrian saddle.

2. The cover for an equestrian saddle of claim 1, wherein said stirrup-egress comprises a stirrup-egress-aperture.

3. The cover for an equestrian saddle of claim 2, wherein said stirrup-egress-aperture is substantially oval-shaped.

4. The cover for an equestrian saddle of claim 3, wherein said flexible sheet comprises a substantially triangulated shape with rounded corners.

5. The cover for an equestrian saddle of claim 4, wherein the flexible sheet comprises a flexible body.

6. The cover for an equestrian saddle of claim 5, wherein the substantially triangulated shape comprises ears.

7. The cover for an equestrian saddle of claim 6, wherein the stirrups are positioned adjacent the ears during an in-storage condition.

8. The cover for an equestrian saddle of claim 7, wherein the stirrups hang in as-ridden-stance, but half way up, when positioned for said in-storage condition against an outer surface of said flexible sheet.

9. The cover for an equestrian saddle of claim 8, wherein the cover comprises an inner volume during said in-storage condition.

10. The cover for an equestrian saddle of claim 9, wherein the cover comprises fleece.

11. The cover for an equestrian saddle of claim 1, wherein the cover further comprises billet-strap-openings in a seam-section.

12. The cover for an equestrian saddle of claim 1, wherein the elastic aperture comprises at least one elastic member.

13. The cover for an equestrian saddle of claim 1, wherein the cover is able to fit under a second-cover.

14. The cover for an equestrian saddle of claim 1, wherein the flexible sheet does not comprise abrasive material.

15. The cover for an equestrian saddle of claim 1, wherein the flexible sheet is readily deformable to fit a host of said saddles which differ in shape and size.

16. The cover for an equestrian saddle of claim 1, wherein the flexible sheet absorbs impact.

17. A saddle cover system, the saddle cover system comprising:
a saddle cover including a flexible body defined by an outer surface, an inner volume, a thickness, and an inner surface, said outer surface being integral with said inner surface and separated via said thickness, said flexible body configured to substantially wrap about a saddle during an in-storage condition to protect said saddle from damage, said flexible body further having a stirrup-egress-aperture, and
wherein said saddle cover allows said saddle to be covered via said flexible body substantially within said inner volume, and stirrups to egress from said stirrup-egress-aperture to be placed adjacent said outer surface of said flexible body such that said stirrups are isolated from touching said saddle during storage.

18. The saddle cover system of claim 17, further comprising set of instructions; and
wherein the saddle cover is arranged as a kit.

19. A method of use for a saddle cover system, the method comprising the steps of:
inserting a saddle within an inner volume of a saddle cover,
pulling stirrups through a stirrup-egress-aperture, and
placing said stirrups adjacent an outer surface such that said stirrups do not contact said saddle during an in-storage condition.

20. The method of claim 19, further comprising the step of placing billets through said saddle cover.
